(19) United States
(12) Patent Application Publication
(10) Pub. No.: US 2019/0214851 A1
(43) Pub. Date: Jul. 11, 2019

(54) POWER SUPPLY DEVICE

(71) Applicant: SHARP KABUSHIKI KAISHA, Sakai City, Osaka (JP)

(72) Inventors: MASATO SASAKI, Sakai City (JP); HIROSHI KOTAKI, Sakai City (JP); HIROSHI KAWAMURA, Sakai City (JP); AKIHIDE SHIBATA, Sakai City (JP); HIROSHI ITOH, Sakai City (JP)

(21) Appl. No.: 16/302,631

(22) PCT Filed: May 12, 2017
(86) PCT No.: PCT/JP2017/017986

§ 371 Date: Nov. 17, 2018

(30) Foreign Application Priority Data
May 19, 2016 (JP) 2016-100506

(51) Int. Cl. H02J 50/10; H01F 38/14

(52) U.S. Cl. CPC H02J 50/10; H02J 7/025; H01F 38/14

(57) ABSTRACT

A power supply device including at least two power transmission coils is provided. The directions of the planes of at least two power transmission coils are different from each other. The frequencies of the at least two power transmission coils are different from each other. Preferably, the at least two power transmission coils include at least three power transmission coils. The directions of the planes of the at least three power transmission coils are different from each other.

### TECHNICAL FIELD

This application is based upon and claims the benefit of priority of the prior Japanese Patent Application No. 2016-100506, filed on May 19, 2016, the entire contents of which are incorporated herein by reference.

The present disclosure relates to a technique for supplying power to an electrical appliance.

### BACKGROUND ART

Conventionally, a technique for supplying power to an electrical appliance has been known. For example, In Japanese Unexamined Patent Application Publication 2013-247718 (PTL 1), a wireless power transmission device is disclosed. According to PTL 1, this wireless power transmission device includes a plurality of power transmission side resonators, a movable power reception side resonator more compact than the power transmission side resonators, and a controller for controlling excitation of the plurality of power transmission side resonators. The resonance frequencies of the power transmission side resonators and the power reception side resonator are matched, the power transmission side resonators are arranged so as to be substantially orthogonal to each other, and the power transmission side resonators are excited with a phase difference of 90° and transmit power to the power reception side resonator.

Furthermore, in U.S. Patent Application Publication No. 2015/0054344 (PTL 2), three power transmission coils are arranged so as to be orthogonal to each other, the phases of exciting currents of a second power transmission coil and a third power transmission coil are displaced from the phase of a first power transmission coil by 90°, and the amplitudes are frequency-modulated to rotate a magnetic field vector, so that suppression of reduction in a coupling coefficient is implemented in a case where a relative orientation of a power reception coil is changed.

### CITATION LIST

### Patent Literature

PTL 1: Japanese Unexamined Patent Application Publication No. 2013-247718
PTL 2: U.S. Patent Application Publication No. 2015/0054344

### SUMMARY OF DISCLOSURE

### Technical Problem

A technique enabling further easier power supply than with a conventional technique is demanded. It is an objective of an aspect of the disclosure to provide a power supply device that enables power supply easier than with a conventional technique.

### Solution to Problem

According to an aspect of the present disclosure, a power supply device including at least two power transmission coils is provided. The directions of the planes of the at least two power transmission coils are different from each other. The frequencies of the at least two power transmission coils are different from each other.

Preferably, the at least two power transmission coils include at least three power transmission coils. The directions of the planes of the at least three power transmission coils are different from each other.

Preferably, the frequencies of the at least three power transmission coils are different from each other.

Preferably, in the at least three power transmission coils, the difference between the highest frequency and the second highest frequency is different from the difference between the second highest frequency and the third highest frequency.

Preferably, two coils out of the at least three coils have the same frequency and the two coils have different directions of plane and different phases from each other.

Preferably, the power supply device has a stand for placing an electrical appliance targeted for power supply.

### Advantageous Effects of Disclosure

As described above, according to an aspect of the present disclosure, a power supply device that enables power supply further easier than with a conventional technique is provided.

### BRIEF DESCRIPTION OF DRAWINGS

FIG. 1 is an image diagram illustrating an overall configuration of a power supply device 100 according to a first embodiment.

FIG. 2 is an image diagram illustrating configurations of first to third power transmission coil units 110, 120, and 130 including first to third power transmission coils 111, 121, and 131 according to the first embodiment.

FIG. 3 is an image diagram illustrating an arrangement configuration of power transmission coils and a locus of a magnetic field vector of a two-dimensional same-frequency power supply device.

FIG. 4 is an image diagram illustrating an arrangement configuration of power transmission coils and a locus of a magnetic field vector of a three-dimensional same-frequency power supply device.

FIG. 5 is an image diagram illustrating drive waveforms of the first to third power transmission coils according to the first embodiment.

FIG. 6 is an image diagram illustrating a locus of a magnetic field vector according to the first embodiment.

FIG. 7 is an image diagram illustrating a locus of a magnetic field vector according to a second embodiment.

FIG. 8 is an image diagram illustrating drive waveforms of first to third power transmission coils according to a third embodiment.

FIG. 9 is a first image diagram illustrating a locus of a magnetic field vector according to the third embodiment.

FIG. 10 is a second image diagram illustrating a locus of a magnetic field vector according to the third embodiment.

FIG. 11 is an image diagram illustrating an overall configuration of a power supply device 100B according to a fourth embodiment.

FIG. 12 is an image diagram illustrating a configuration of first to third power transmission coils according to a fifth embodiment.

FIG. 13 is an image diagram illustrating an arrangement configuration of first to third power transmission coils 111, 121, and 131 according to a seventh embodiment.

FIG. 14 is an image diagram illustrating drive waveforms of the first and second power transmission coils according to the seventh embodiment.

FIG. 15 is an image diagram illustrating a locus of a magnetic field vector according to the seventh embodiment.

FIG. 16 is an image diagram illustrating an overall configuration of a first power supply device 1000 according to the seventh embodiment.

FIG. 17 is an image diagram illustrating an overall configuration of a second power supply device 100E according to the seventh embodiment.

FIG. 18 is a first image diagram illustrating configurations of first to third power transmission coil units 110, 120, and 130 according to the first to seventh embodiments.

FIG. 19 is a second image diagram illustrating configurations of the first to third power transmission coil units 110, 120, and 130 according to the first to seventh embodiments.

### DESCRIPTION OF EMBODIMENTS

Hereinafter, embodiments of the present disclosure will be described with reference to the drawings. In the description below, the same components will be denoted with the same reference character. These components have the same name and function. Accordingly, the detailed description thereof will not be repeated.

### First Embodiment

### <Overall Configuration and Operation Outline of Power Supply Device 100>

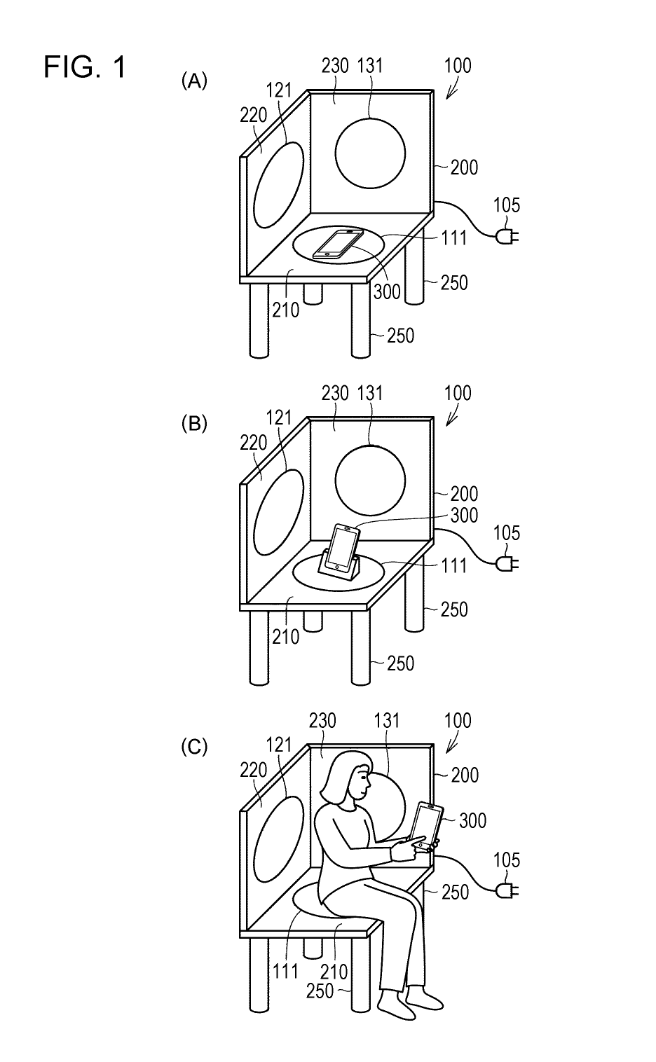

An overall configuration of a power supply device 100 according to the present embodiment will be described. FIG. 1 is an image diagram illustrating an overall configuration of a power supply device 100 according to the present embodiment.

With reference to FIG. 1(A), the power supply device 100 according to the present embodiment includes a stand 200 for placing an electrical appliance targeted for power supply, for example, a smartphone 300. The stand 200 includes a horizontal member 210 supported by a plurality of legs 250 and a longitudinal vertical member 220 and a lateral vertical member 230 which are erected from the horizontal member 210.

The horizontal member 210 includes therein a first power transmission coil ill. The longitudinal vertical member 220 includes therein a second power transmission coil 121. The lateral vertical member 230 includes therein a third power transmission coil 131. To each of the first to third power transmission coils 111, 121, and 131, an electric current with a prescribed frequency is applied using power from a plug 105 via a control circuit, which will be described later, that controls a frequency and a phase.

With this, the power supply device 100 according to the present embodiment is able to charge the smartphone 300 having a power reception coil even if the smartphone 300 is placed in various postures. For example, as illustrated in FIG. 1(A), the smartphone 300 laid on the horizontal member 210 can be charged, and as illustrated in FIG. 1(B), the smartphone 300 standing on a stand can be charged. Furthermore, as illustrated in FIG. 1(C), the smartphone 300 held in a hand of a user, put in a bag or a pocket, or the like can be charged, for example. A configuration of the power supply device 100 as described above will be described in more details below.

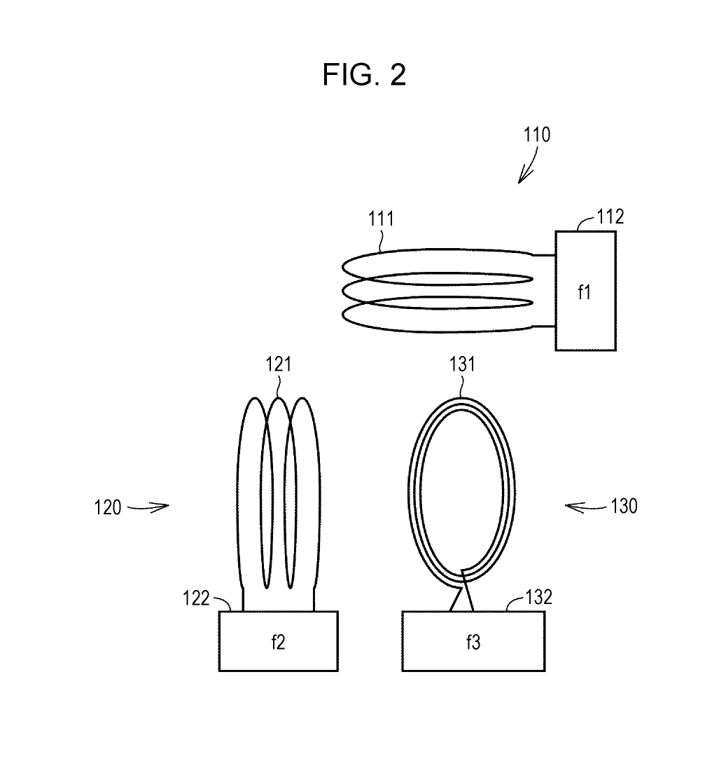

First, the first to third power transmission coils 111, 121, and 131 will be described. FIG. 2 is an image diagram illustrating configurations of first to third power transmission coil units 110, 120, and 130 including the first to third power transmission coils 111, 121, and 131 according to the present embodiment.

With reference to FIG. 2, the first power transmission coil unit 110 includes the first power transmission coil 111 for generating a magnetic field for power supply and a first control circuit 112 for driving the first transmission coil 111 using power acquired from a power source. The first power transmission coil 111 is wounded for a plurality of times in parallel with a horizontal plane, in the present embodiment, with an x-z plane. The control circuit 112 drives the first power transmission coil 111 with a prescribed frequency and in a prescribed phase using the power supplied from the plug 105.

The second power transmission coil unit 120 includes the second power transmission coil 121 for generating a magnetic field for power supply and a second control circuit 122 for driving the second power transmission coil 121 using power acquired from a power source. The second power transmission coil 121 is wounded for a plurality of times in parallel with a vertical plane, in the present embodiment, with a y-z plane. The control circuit 122 drives the second power transmission coil 121 with a prescribed frequency and in a prescribed phase using the power supplied from the plug 105.

The third power transmission coil unit 130 includes the third power transmission coil 131 for generating a magnetic field for power supply and a third control circuit 132 for driving the third transmission coil 131 using power acquired from a power source. The third power transmission coil 131 is wounded for a plurality of times in parallel with a vertical plane, in the present embodiment, with an x-y plane. The control circuit 132 drives the third power transmission coil 131 with a prescribed frequency and in a prescribed phase using the power supplied from the plug 105.

### <Two-Dimensional Same-Frequency Power Supply Device>

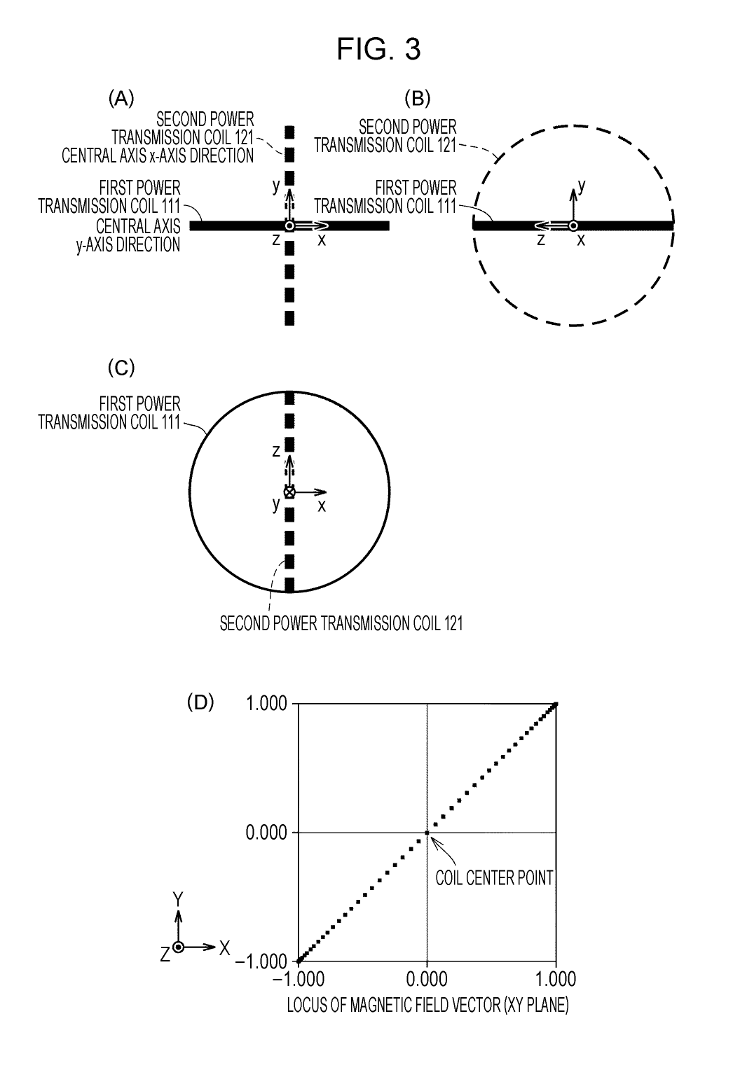

At this point, first, a two-dimensional same-frequency power supply device will be described. FIG. 3 is an image diagram illustrating an arrangement configuration of power transmission coils and a locus of a magnetic field vector of a two-dimensional same-frequency power supply device.

With reference to FIG. 3, the two-dimensional same-frequency power supply device includes the first power transmission coil 111 and the second power transmission coil 121 arranged in the vertical direction to each other. More specifically, (A) is a diagram illustrating an arrangement configuration of the first power transmission coil 11 and the second power transmission coil 121 viewed from the z direction. (B) is a diagram illustrating an arrangement configuration of the first power transmission coil 111 and the second power transmission coil 121 viewed from the x direction. (C) is a diagram illustrating an arrangement configuration of the first power transmission coil 111 and the second power transmission coil 121 viewed from the y direction.

The two-dimensional same-frequency power supply device drives the first power transmission coil 111 and the second power transmission coil 121 with a phase difference of 0 and with the same frequency to generate a magnetic field. In this case, as illustrated in FIG. 3(D), the end positions of the magnetic field vectors draw a linear locus centering on the center of a coil. With this, when a power reception coil of an electrical appliance at the power reception side is arranged in parallel with the linear locus, power supply to the electrical appliance is failed.

### <Three-Dimensional Same-Frequency Power Supply Device>

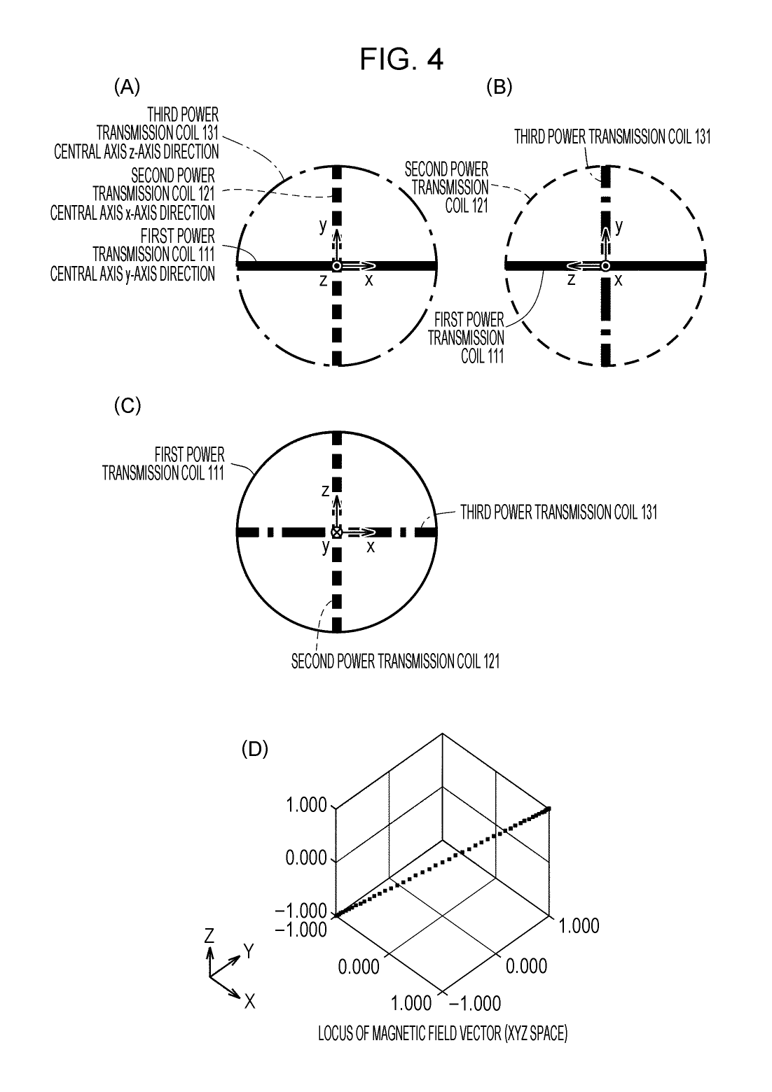

Next, a three-dimensional same-frequency power supply device will be described. FIG. 4 is an image diagram illustrating an arrangement configuration of power transmission coils and a locus of a magnetic field vector of a three-dimensional same-frequency power supply device.

With reference to FIG. 4, the three-dimensional same-frequency power supply device includes the first power transmission coil ill, the second power transmission coil 121, and the third power transmission coil 131 arranged in the vertical direction to each other. More specifically, (A) is a diagram illustrating an arrangement configuration of the first power transmission coil 111, the second power transmission coil 121, and the third power transmission coil 131 viewed from the z direction. (B) is a diagram illustrating an arrangement configuration of the first power transmission coil ill, the second power transmission coil 121, and the third power transmission coil 131 viewed from the x direction. (C) is a diagram illustrating an arrangement configuration of the first power transmission coil 111, the second power transmission coil 121, and the third power transmission coil 131 viewed from the y direction.

The three-dimensional same-frequency power supply device drives the first power transmission coil 111, the second power transmission coil 121, and the third power transmission coil 131 with a phase difference of 0 and with the same frequency to generate a magnetic field. In this case, as illustrated in FIG. 4(D), the end positions of the magnetic field vectors draw a linear locus centering on the center of a coil. With this, when a power reception coil of an electrical appliance at the power reception side is arranged in parallel with the linear locus, power supply to the electrical appliance is failed.

### <Three-Dimensional Different-Frequency Power Supply Device>

Next, a power supply device 100 using three-dimensional different frequencies according to the present embodiment will be described. Arrangement configurations of the first power transmission coil 111, the second power transmission coil 121, and the third power transmission coil 131 are the same as illustrated in FIG. 1, FIG. 2, FIG. 4, and the like, and thus the descriptions will not be repeated here.

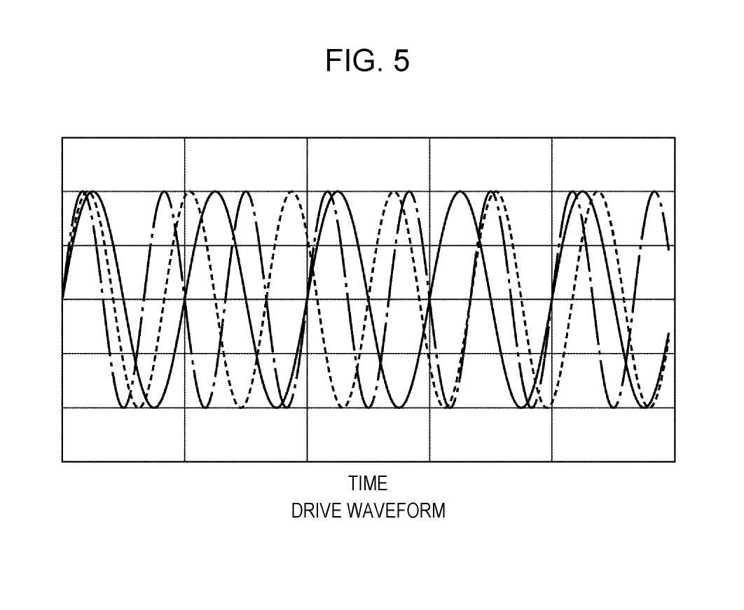

In the present embodiment, coil planes of the first power transmission coil 111, the second power transmission coil 121, and the third power transmission coil 131 are arranged so as to be vertical to each other. Furthermore, the frequencies of the first power transmission coil 111, the second power transmission coil 121, and the third power transmission coil 131 are set so as to be different from each other, as illustrated in FIG. 5.

For example, the first control circuit 112 drives the first power transmission coil 111 with a frequency f1=100 kHz using power supplied from the plug 105. The second control circuit 122 drives the second power transmission coil 121 with a frequency f2=102 kHz using power supplied from the plug 105. The control circuit 132 drives the third power transmission coil 131 with a frequency f3=104 kHz using power supplied from the plug 105.

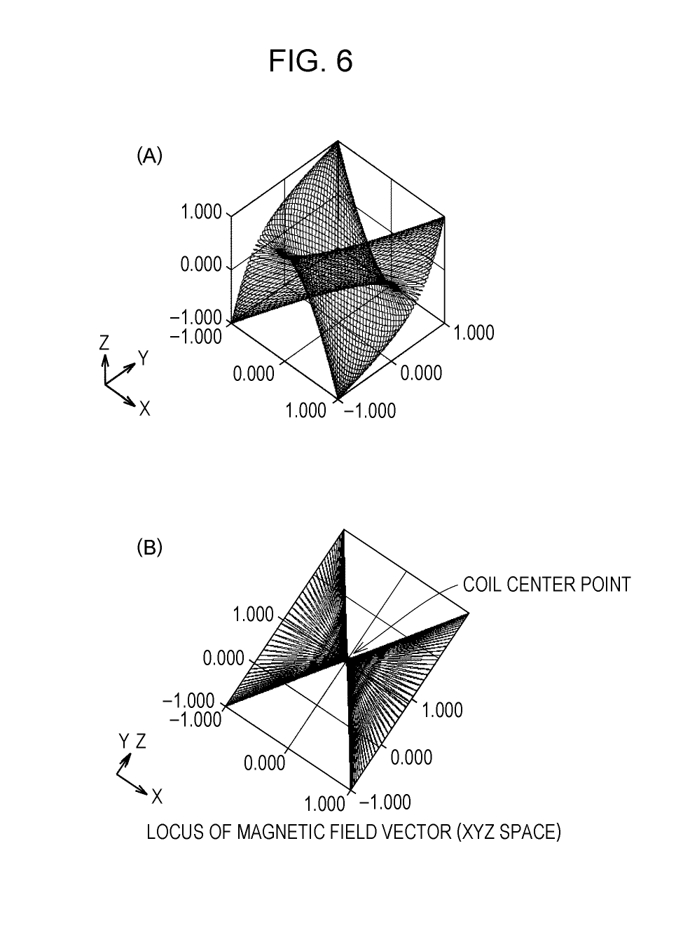

In this case, as illustrated in FIG. 6, the end positions of the magnetic field vectors are three-dimensionally distributed, that is, do not gather in a linear shape or on a plane. With this, even if a power reception coil of an electrical appliance at the power reception side is placed in various postures, power supply is enabled.

More specifically, when each of the first power transmission coil, the second power transmission coil, and the third power transmission coil has a different frequency from each other, the end positions of the magnetic field vectors are three-dimensionally distributed, that is, do not gather in a linear shape or on a plane. With this, even if a power reception coil of an electrical appliance at the power reception side is placed in various postures, power supply is enabled.

That is to say, according to the power supply device 100 of the present embodiment, as illustrated in FIG. 1(C), the electrical appliance 300 at the power reception side is able to receive power even in a state of being held in a hand of a user to be used or being carried by a user. Furthermore, according to the power supply device 100 of the present embodiment, the electrical appliance 300 at the power reception side is able to receive power regardless of the position of the power reception coil even when the electrical appliance 300 is formed in a complicated shape like an electronic tool, so that the way of placing the electrical appliance 300 on a plane is not uniformly fixed.

It is to be noted that when only two out of the first power transmission coil, the second power transmission coil, and the third power transmission coil have the same frequency, the end positions of the magnetic field vectors are positioned on a plane, not in a linear shape. In this case also, compared with the two-dimensional same-frequency power supply device and the three-dimensional same-frequency power supply device, the number of arrangement patterns of power reception coils of the electrical appliance at the power reception side, in which power reception is enabled, can be increased.

### Second Embodiment

In the first embodiment, each of the first power transmission coil, the second power transmission coil, and the third power transmission coil has a different frequency from each other. However, the difference (f2−f1) between the frequency f2 for the second power transmission coil and the frequency f1 for the first power transmission coil is the same as the difference (f3−f2) between the frequency f3 for the third power transmission coil and the frequency f2 for the second power transmission coil. However, the present disclosure is not limited to the form as described above.

In particular, when f1<f2<f3 is satisfied, |f2−f1|≥2 kHz or |f3−f2|≥2 kHz is preferably satisfied. A frequency difference may cause a risk that the rotation period of a magnetic field vector becomes long, and thus, a period during which the magnetic fields do not cross each other becomes long at the power reception coil side. Furthermore, |f3/(f1+f2+f3)/3|≤1.2 or |f1/(f1+f2+f3)/3|≤1.2 is preferably satisfied.

In the present embodiment, each of the first power transmission coil, the second power transmission coil, and the third power transmission coil has a different frequency from each other. A frequency difference with respect to a pair composing two coils out of these coils is different from a frequency difference with respect to other pairs. That is to say, when power supply devices 100 include three power transmission coils, the difference between the power transmission coil with the highest frequency and the power transmission coil with the second highest frequency is different from the difference between the power transmission coil with the second highest frequency and the power transmission coil with the third highest frequency.

For example, the first control circuit 112 drives the first power transmission coil 111 with a frequency f1=100 kHz using power supplied from the plug 105. The second control circuit 122 drives the second power transmission coil 121 with a frequency f2=103 kHz using power supplied from the plug 105. The third control circuit 132 drives the third power transmission coil 131 with a frequency f3=107 kHz using power supplied from the plug 105.

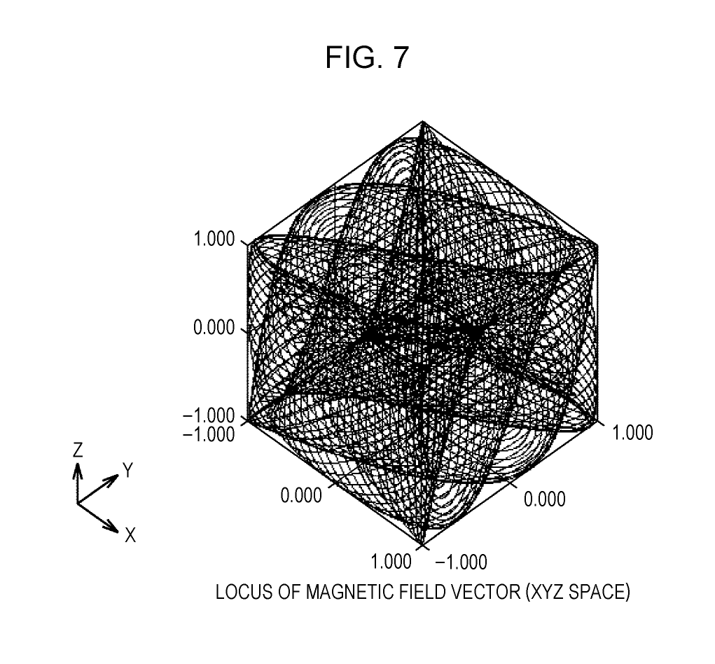

In this case, as illustrated in FIG. 7, the end positions of the magnetic field vectors are three-dimensionally and further uniformly distributed. With this, even if a power reception coil of an electrical appliance at the power reception side is placed in various postures, efficient power supply is enabled.

### Third Embodiment

In the first embodiment, each of the first power transmission coil, the second power transmission coil, and the third power transmission coil has a different frequency from each other. However, the present disclosure is not limited to the form as described above. In the present embodiment, out of the first power transmission coil, the second power transmission coil, and the third power transmission coil, only one has a different frequency from that of other two. That is to say, the other two power transmission coils have the same frequency, and these coils to which the same frequency is set have different phases from each other.

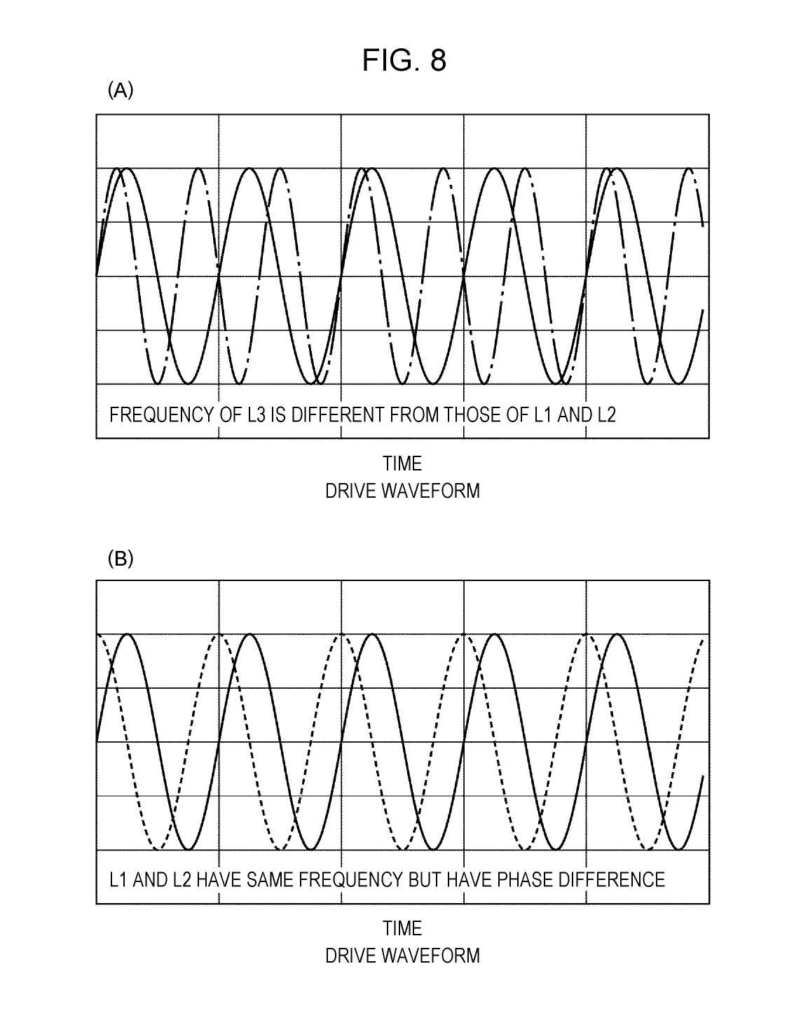

For example, as illustrated in FIG. 8(A), the first control circuit 112 drives the first power transmission coil 111 with a frequency f1=100 kHz using power supplied from the plug 105. The second control circuit 122 drives the second power transmission coil 121 with a frequency f2=100 kHz using power supplied from the plug 105. The third control circuit 132 drives the third power transmission coil 131 with a frequency f3=105 kHz using power supplied from the plug 105.

Furthermore, as illustrated in FIG. 8(B), at least, the control circuit 112 and the control circuit 122 that provide the same frequency drive the first power transmission coil 111 and the second power transmission coil 121 using power supplied from the plug 105 such that the phases thereof are displaced by 90°.

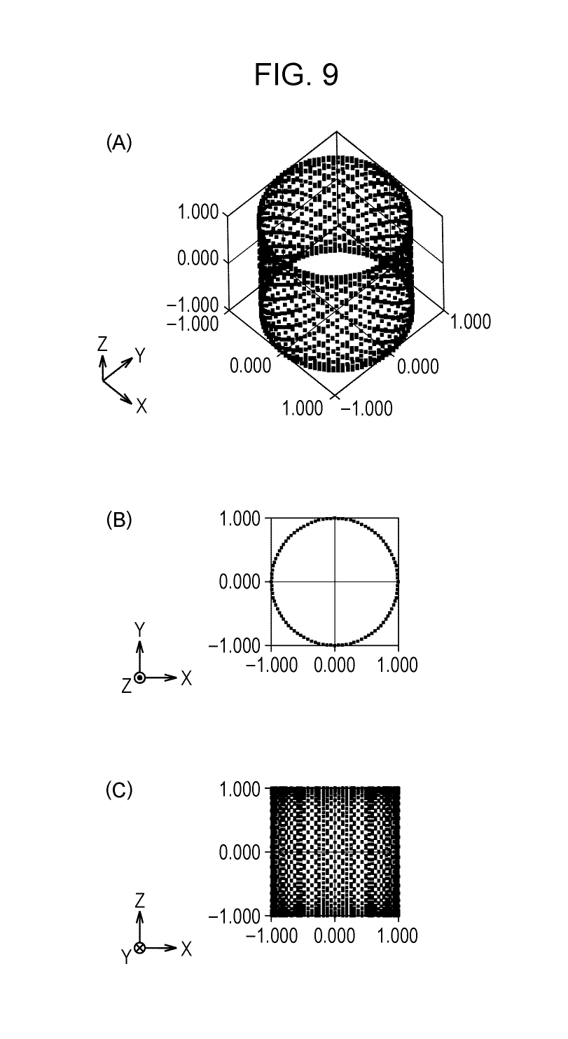

In this case, as illustrated in FIG. 9, the end positions of the magnetic field vectors are three-dimensionally distributed, that is, do not gather in a linear shape or on a plane. With this, even if a power reception coil of an electrical appliance at the power reception side is placed in various postures, power supply is enabled.

Alternatively, at least, the control circuit 112 and the control circuit 122 that provide the same frequency drive the first power transmission coil 111 and the second power transmission coil 121 using power supplied from the plug 105 such that the phases thereof are displaced by 45°.

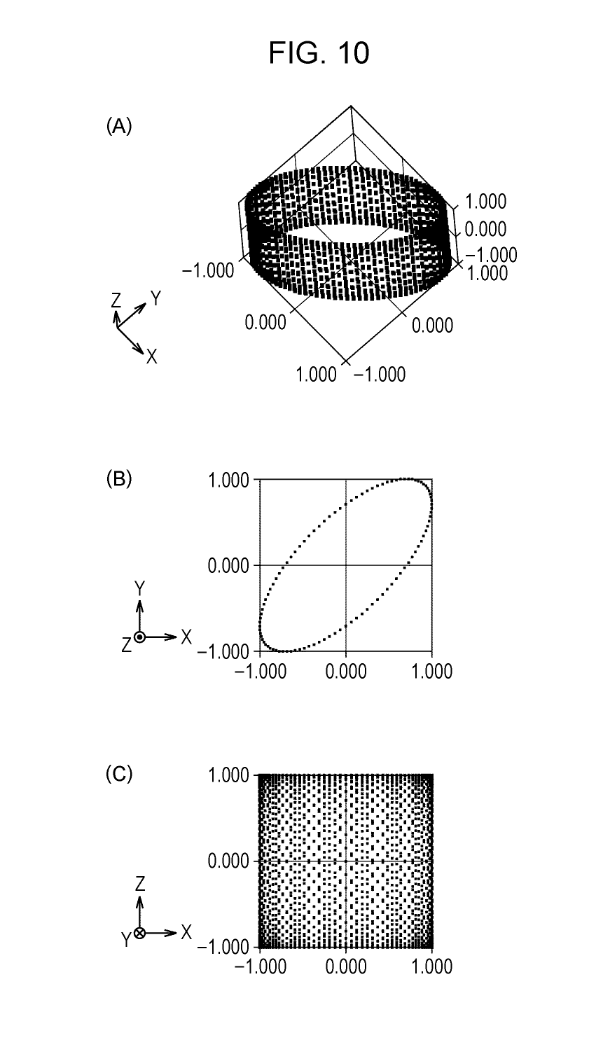

In this case, as illustrated in FIG. 10, the end positions of the magnetic field vectors are three-dimensionally distributed, that is, do not gather in a linear shape or on a plane. With this, even if a power reception coil of an electrical appliance at the power reception side is placed in various postures, power supply is enabled.

### Fourth Embodiment

In the first to third embodiments, the power supply device 100 has one area for placing an electrical appliance. However, the present disclosure is not limited to the form as described above.

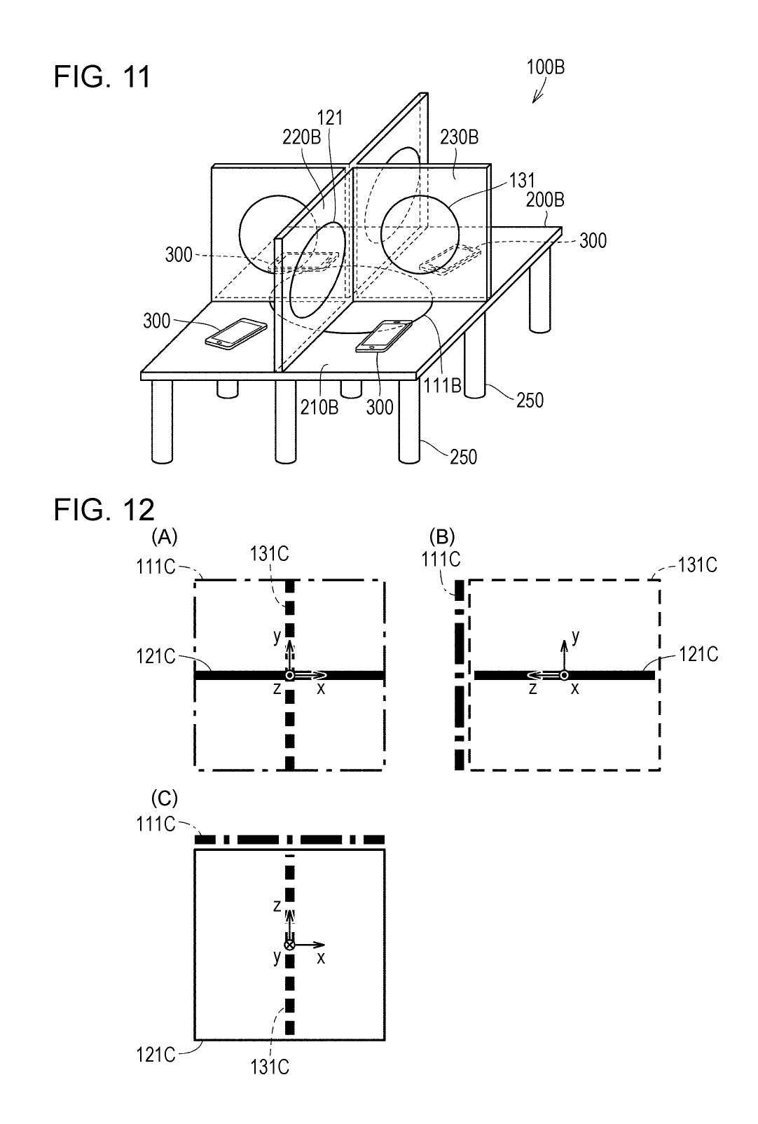

For example, as illustrated in FIG. 11, a power supply device 100B includes a stand 200B for placing an electrical appliance targeted for power supply, for example, the smartphone 300. The stand 200B includes a horizontal member 210B supported by a plurality of legs 250, and a longitudinal vertical member 220B and a lateral vertical member 230B which are erected to section the horizontal member 210B into a plurality of areas.

The horizontal member 210B includes therein a first power transmission coil 111B. The longitudinal vertical member 220B includes therein a plurality of second power transmission coils 121. The lateral vertical member 230B includes therein a plurality of third power transmission coils 131. To each of the first to third power transmission coils 111B, 121, and 131, a prescribed alternating current is applied using power supplied from the plug 105 or the like via a control circuit that controls a frequency and a phase.

With this, the power supply device 100B according to the present embodiment is able to charge the smartphone 300 laid on the horizontal member 210 in each of the plurality of areas, and able to charge the smartphone 300 standing on a stand in each of the plurality of areas. It is to be noted that the arrangement and control for each of the first to third power transmission coils 111B, 121, and 131 is the same as that in the first to third embodiments, and thus the description thereof will not repeated here.

### Fifth Embodiment

In the first to fourth embodiments, each of the first to third power transmission coils 111, 121, and 131 is circularly wounded. However, the present disclosure is not limited to the form as described above.

For example, as illustrated in FIG. 12, first to third power transmission coils 111C, 121C, and 131C may be wounded in a rectangular shape or in other polygonal shape.

### Sixth Embodiment

In the first to fifth embodiments, the power supply device has three power transmission coils whose coil planes are orthogonal to each other. However, the present disclosure is not limited to the form as described above.

For example, the power supply device may have three power transmission coils whose arrangement directions and postures are different from each other, and may have four or more power transmission coils whose arrangement directions and postures are different from each other. It is to be noted that the frequency and phase control for each of the power transmission coils is the same as that in the first to fifth embodiments, and thus, the description thereof will not repeated here.

### Seventh Embodiment

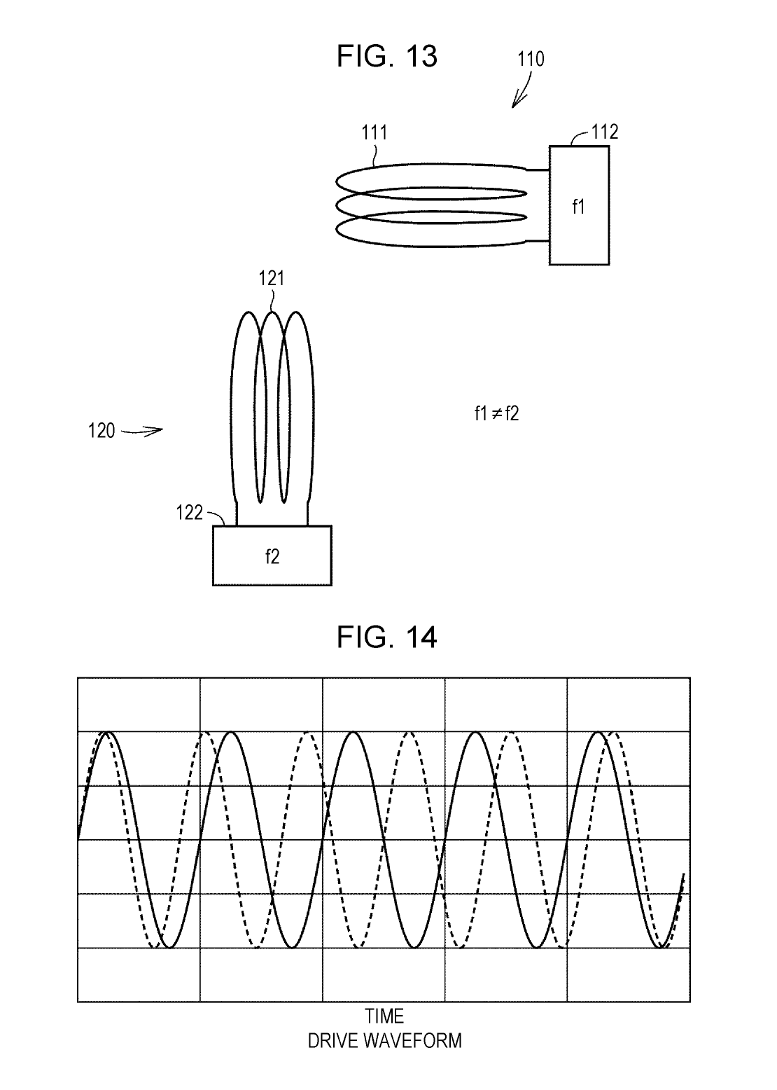

Furthermore, as illustrated in FIG. 13, a power supply device 100D may include the first power transmission coil 111 and the second power transmission coil 121 whose directions of the coil planes are different from each other, for example, orthogonal to each other. In the present embodiment, the frequencies of the first power transmission coil 111 and the second power transmission coil 121 are set so to be different from each other, as illustrated in FIG. 14.

For example, the control circuit 112 drives the first power transmission coil 111 with a frequency f1=100 kHz using power supplied from the plug 105. The control circuit 112 drives the second power transmission coil 121 with a frequency f2=102 kHz using power supplied from the plug 105.

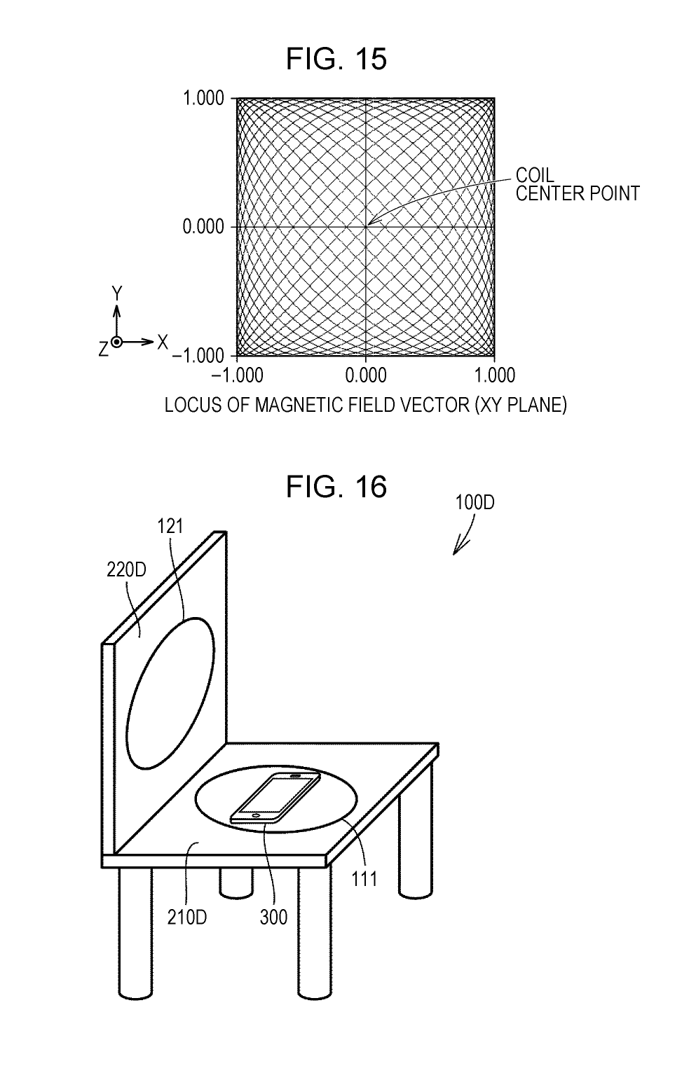

In this case, as illustrated in FIG. 15, the end positions of the magnetic field vectors are distributed on a plane, that is, do not gather in a linear shape. With this, unless a power reception coil of an electrical appliance at the power reception side is placed in parallel with the plane, power supply is enabled.

Specifically, for example, as illustrated in FIG. 16, the power supply device 100D according to the present embodiment includes a stand 200D for placing an electrical appliance targeted for power supply, for example, the smartphone 300. The stand 200D includes a horizontal member 210D supported by a plurality of legs 250 and a longitudinal vertical member 220D erected from the horizontal member 210D.

Furthermore, the horizontal member 210D includes therein a first power transmission coil 111. The longitudinal vertical member 220D includes therein the second power transmission coil 121. To each of the first and second power transmission coils 111 and 121, a prescribed alternating current is applied using power supplied from the plug 105 via a control circuit that controls a frequency and a phase.

With this, the power supply device 100D according to the present embodiment is able to charge the smartphone 300 laid on the horizontal member 210D, and able to charge the smartphone 300 standing on a stand unless the smartphone 300 stands vertically to both the horizontal member 210D and the longitudinal vertical member 220D.

Alternatively, for example, as illustrated in FIG. 17, the power supply device 100E may be formed of the power supply devices 100D arranged in parallel with each other. That is to say, the power supply device 100D may be formed of the horizontal members 210D each including therein the first power transmission coil 111 and being arranged in parallel with each other and the longitudinal vertical members 220D each including therein the second power transmission coil 121 and being arranged in parallel with each other.

It is to be noted that in the power supply device 100E, the plurality of power supply devices 100D are preferably arranged laterally at 900 or obliquely with each other, not in parallel with each other. With this, the second power transmission coil 121 of a first power supply device 100D and the second power transmission coil 121 of a second power supply device 100D are not parallel with each other, whereby the end positions of the magnetic field vectors are three-dimensionally distributed. That is to say, the end positions of the magnetic field vectors do not gather on a plane. With this, even if a power reception coil of an electrical appliance at the power reception side is placed in various postures, power supply is enabled.

Furthermore, the first and second power transmission coils 111 and 121 may be wounded in a rectangular shape or in other polygonal shape.

Furthermore, the power supply device is not limited to one having power transmission coils which are orthogonal to each other, and may be one having two power transmission coils whose arrangement directions and postures are different from each other.

### <Supplement>

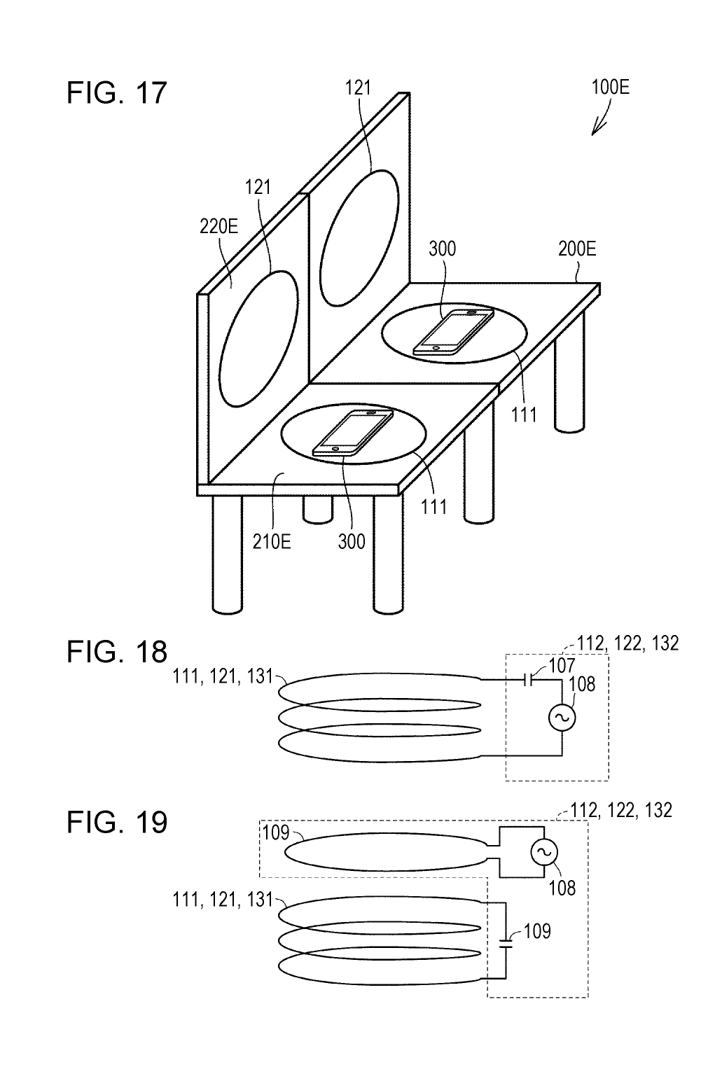

The configuration of the control circuits 112, 122, and 132 according to the first to seventh embodiments are not especially limited as long as a prescribed frequency and a prescribed phase can be given to each of the first to third coils. For example, the control circuits 112, 122, and 132 may be formed by an alternating current power source 108 and a capacitor 107 as illustrated in FIG. 18, and may be formed by the capacitor 107, the alternating current power source 108, and a power transmission coil 109 different from the first to third power transmission coils 111, 121, and 131 as illustrated in FIG. 19.

It is to be noted that with respect to the power supply devices according to the first to seventh embodiments, as an electronic device targeted for power supply, an example with a smartphone has been cited. However, the electronic device is not limited to a smartphone, and may be a mobile electronic device such as a notebook PC or a portable game console, a wearable terminal such as wireless headphones or a wrist watch type electronic device, an electric tool, or the like, for example.

It is to be noted that the frequencies for driving the first to third power transmission coils 111, 121, and 131 according to the first to seventh embodiments are not limited to those in the above-described embodiments. The frequencies for driving the first to third power transmission coils 111, 121, and 131 may be selected as appropriate from a range that could have been normally set by the skilled person.

Furthermore, a difference in the frequencies of the power transmission coils 111, 121, and 131 having different frequencies is preferably equal to or higher than 2 kHz. When a difference in the frequencies of the power transmission coils 111, 121, and 131 having different frequencies is less than 2 kHz, the rotation change period of a magnetic field vector becomes long, and thus, a period during which the magnetic fields do not cross each other becomes long at a power reception coil.

Furthermore, when a maximum value of the frequencies driven by the power transmission coils 11, 121, and 131 is fmax, a minimum value of the frequencies driven by the power transmission coils 111, 121, and 131 is fmin, and an average value of the frequencies driven by the first to third power transmission coils 111, 121, and 131 is fave, |fmax−fave|≤1.2 and |fmin−fave|≤1.2 are preferably satisfied. Furthermore, when a circuit at the coil side of the power reception side includes a resonance circuit, variation in the frequencies of the power transmission coils corresponds to variation in the frequencies of the circuit at the power reception side, and is preferably set to be equal to or lower than 20%.

### SUMMARY

In each of the first to seventh embodiments described above, the power supply device 100 that includes at least two power transmission coils 111 and 121 is provided. The directions of the planes of the at least two power transmission coils are different from each other. The frequencies of the at least two power transmission coils are different from each other.

Preferably, the at least two power transmission coils include at least three power transmission coils 111, 121, and 131. The directions of the planes of the at least three power transmission coils 111, 121, and 131 are different from each other.

Preferably, the frequencies of the at least three power transmission coils 111, 121, and 131 are different from each other.

Preferably, in the at least three power transmission coils 111, 121, and 131, the difference between the highest frequency and the second highest frequency is different from the difference between the second highest frequency and the third highest frequency.

Preferably, two coils 111 and 121 out of the at least three coils 111, 121, and 131 have the same frequency and the two coils 111 and 121 have different directions of plane and different phases from each other.

Preferably, the power supply device 100 has the stand 200 for placing the electrical appliance 300 targeted for power supply.

Embodiments disclosed herein are to be considered as not restrictive but illustrative in all respects. The scope of the disclosure is defined by the appended claims rather than by the foregoing description, and is intended to include any modifications within the meaning and range of equivalency of the claims.

### REFERENCE SIGNS LIST

100 power supply device
100B power supply device
100D power supply device
100E power supply device
105 plug
107 capacitor
108 alternating current power source
109 power transmission coil
110 first power transmission coil unit
111 first power transmission coil
112 first control circuit
120 second power transmission coil unit
121 second power transmission coil
122 second control circuit
130 third power transmission coil unit
131 third power transmission coil
132 third control circuit
200 stand
210 horizontal member
220 longitudinal vertical member
230 lateral vertical member
250 leg
300 electrical appliance

1. A power supply device comprising:
at least two coils, wherein
directions of planes of the at least two coils are different from each other, and
frequencies of the at least two coils are different from each other.

2. The power supply device according to claim 1, wherein
the at least two coils include at least three coils, and
directions of planes of the at least three coils are different from each other.

3. The power supply device according to claim 2, wherein
frequencies of the at least three coils are different from each other.

4. The power supply device according to claim 3, wherein
in the at least three coils, a difference between a highest frequency and a second highest frequency is different from a difference between a second highest frequency and a third highest frequency.

5. The power supply device according to claim 2, wherein
two coils out of the at least three coils have the same frequency and the two coils have different directions of plane and different phases from each other.

6. The power supply device according to claim 1, comprising:
a stand for placing an electrical appliance targeted for power supply.

7. The power supply device according to claim 1, wherein the at least two coils are orthogonal to each other.

8. The power supply device according to claim 2, wherein the at least three coils are orthogonal to each other.
